(19) United States
(12) Patent Application Publication
(10) Pub. No.: US 2020/0328789 A1
(43) Pub. Date: Oct. 15, 2020

(54) Constraints-Based Phased Array Calibration

(71) Applicant: Intel Corporation, Santa Clara, CA (US)

(72) Inventors: Dan Pritsker, San Diego, CA (US); Colman Cheung, San Diego, CA (US)

(21) Appl. No.: 16/913,868

(22) Filed: Jun. 26, 2020

(51) Int. Cl. H04B 7/06; H04R 1/40

(52) U.S. Cl. CPC H04B 7/0617; H04R 1/406

(57) ABSTRACT

Systems, methods, and machine-readable media are provided to perform adaptive beamforming using beamformer weights that compensate for undesirable signal path delays of a phased array. Such a system may include an array of elements that receive respective signals, analog-to-digital conversion circuitry to digitize the signals, and adaptive beamforming circuitry that performs beamforming using the digitized signals. The digitized signals used by the adaptive beamforming circuitry may not be aligned in time due to differences in analog delays between the array of elements and the analog-to-digital conversion circuitry. Even so, the adaptive beamforming circuitry may generate beamformer weights that compensate for the analog delays.

### BACKGROUND

The present disclosure relates generally to integrated circuit (IC) devices that operate a phased array using adaptive beamforming.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it may be understood that these statements are to be read in this light, and not as admissions of prior art.

A phased array of sensors (e.g., receivers) or transmitters, such as antennas, microphones, or speakers, may be used to detect or transmit a signal in a particular spatial direction in relation to the phased array. By detecting or transmitting a signal through the phased array at specific offsets in time—that is, using different phase offsets for different sensors or transmitters—the signal may be detected or transmitted in a particular spatial direction. Consider the case of signal detection. A signal arriving at an array of sensors from a particular spatial direction may reach different sensors at different times (e.g., closer sensors first). Thus, selecting specific offsets in time for different sensors causes the results, when added together, to experience constructive interference in that particular spatial direction. Transmitting a signal in a particular direction may operate in a similar way. A signal to be transmitted may be provided to different elements of an array of transmission elements, such as antennas or speakers, at different offsets in time. By selecting specific offsets in time, the resulting transmission signals can be made to constructively interfere (that is, add to one another) in a desired spatial direction.

Adaptive beamforming is one way to create a directional beam while taking into account the presence of other emitters that may interfere with a phased array. To use adaptive beamforming, signals from phased array elements are aligned before processing. In general, the signal paths between the phased array elements and digital circuitry of the integrated circuit may have varying amounts of delay (due to process variations in manufacturing or due to slight differences in the signal path design). Accordingly, to align the signals from the phased array elements, digital skew compensation circuitry may be included on the integrated circuit die. The digital skew compensation circuitry applies respective phase shifts to the signals from the phased array elements to negate the effect of the different signal path delays. This allows the signal paths to be aligned for processing to perform adaptive beamforming. The digital skew compensation circuitry, however, may increase the latency of the signals from the phased array elements while also consuming valuable die space on the integrated circuit.

### BRIEF DESCRIPTION OF THE DRAWINGS

Various aspects of this disclosure may be better understood upon reading the following detailed description and upon reference to the drawings in which:

FIG. 1 is a block diagram of a system that uses an integrated circuit to control a phased array, in accordance with an embodiment of the present disclosure;

FIG. 2 is a block diagram of the integrated circuit device of FIG. 1, in accordance with an embodiment of the present disclosure;

FIG. 3 is a block diagram of a system for adaptive beamforming using digital skew compensation circuitry, in accordance with an embodiment of the present disclosure;

FIG. 4 is a block diagram of a system for adaptive beamforming with reduced or no digital skew compensation circuitry by applying compensation delays into steering vector generation, in accordance with an embodiment of the present disclosure;

FIG. 5 is a flowchart of a method for using the system of FIG. 4, in accordance with an embodiment of the present disclosure; and

FIG. 6 is a data processing system that uses the integrated circuit to control a phased array, in accordance with an embodiment of the present disclosure.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “including” and “having” are intended to be inclusive and mean that there may be additional elements other than the listed elements. Additionally, it should be understood that references to “some embodiments,” “embodiments,” “one embodiment,” or “an embodiment” of the present disclosure are not intended to be interpreted as excluding the existence of additional embodiments that also incorporate the recited features. Furthermore, the phrase A “based on” B is intended to mean that A is at least partially based on B. Moreover, the term “or” is intended to be inclusive (e.g., logical OR) and not exclusive (e.g., logical XOR). In other words, the phrase A “or” B is intended to mean A, B, or both A and B.

An integrated circuit, such as a programmable logic device (PLD) like a field programmable gate array (FPGA), may use adaptive beamforming to control a phased array. As mentioned above, the (primarily analog) signal paths between the phased array elements and digital circuitry of the integrated circuit may have varying amounts of delay (due to process variations in manufacturing or due to slight differences in the signal path design). To use adaptive beamforming, precise phase offsets are selected for different elements of the phased array. Thus, variations in delay of the analog signal paths could impact the effectiveness of adaptive beamforming if not fully accounted for. Indeed, these undesirable variations in signal path delays may be referred to as signal path delay errors.

In this disclosure, the integrated circuit may account for the varying analog signal path delays without fully aligning the signals from the phased array elements before processing. Thus, digital skew compensation circuitry to align signals from phased array elements before processing may be reduced or eliminated entirely. Indeed, rather than fully align signals of phased array elements before processing, digitized signals of the phased array elements may be received by adaptive beamforming circuitry of the integrated circuit without alignment. Instead, compensation delay values may be incorporated into adaptive beamforming calculations used to determine phase offsets for beamforming using the unaligned signals from the phase array elements. Reducing or eliminating digital skew compensation circuitry in this way may significantly improve the latency of adaptive beamforming. Moreover, because adaptive beamforming calculations may take place at a lower computational rate compared to the signals inline to the phased array elements. Accordingly, compensating for analog signal path delays in the adaptive beamforming calculations may reduce the computational burden involved in compensating for the delays. Reducing or eliminating the digital skew compensation circuitry may also reduce the amount of die space used on the integrated circuit. It should be appreciated that, while the discussion below focuses on applying adaptive beamforming to receiving signals from a phased array, the techniques discussed below may also be adapted to be used to transmit signals via a phased array without using digital skew compensation circuitry along the datapath.

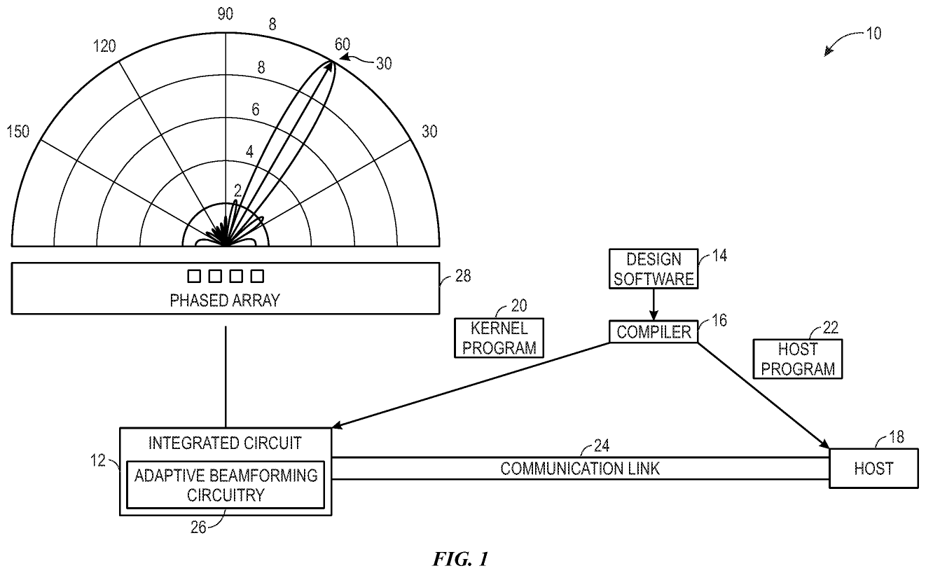

With this in mind, FIG. 1 illustrates a block diagram of a system 10 that may implement adaptive beamforming of a phased array. A designer may desire to implement functionality, such as the efficient adaptive beamforming for a phased array of this disclosure, on an integrated circuit device 12 (such as a field-programmable gate array (FPGA) or an application-specific integrated circuit (ASIC)). In some cases, the designer may specify a high-level program to be implemented, such as an OpenCL program, which may enable the designer to more efficiently and easily provide programming instructions to configure a set of programmable logic cells for the integrated circuit device 12 without specific knowledge of low-level hardware description languages (e.g., Verilog or VHDL). For example, because OpenCL is quite similar to other high-level programming languages, such as C++, designers of programmable logic familiar with such programming languages may have a reduced learning curve than designers that are required to learn unfamiliar low-level hardware description languages to implement new functionalities in the integrated circuit device 12.

Designers may implement their high-level designs using design software 14, such as a version of Intel® Quartus® Prime by INTEL CORPORATION. The design software 14 may use a compiler 16 to convert the high-level program into a lower-level description. The compiler 16 may provide machine-readable instructions representative of the high-level program to a host 18 and the integrated circuit device 12. The host 18 may receive a host program 22 which may be implemented by the kernel programs 20. To implement the host program 22, the host 18 may communicate instructions from the host program 22 to the integrated circuit device 12 via a communications link 24, which may be, for example, direct memory access (DMA) communications or peripheral component interconnect express (PCIe) communications. While the techniques described above refer to the application of a high-level program, in some embodiments, a designer may use the design software 14 to generate and/or to specify a low-level program, such as the low-level hardware description languages described above. Further, in some embodiments, the system 10 may be implemented without a separate host program 22. Moreover, in some embodiments, the techniques described herein may be implemented in circuitry as a non-programmable circuit design. Thus, embodiments described herein are intended to be illustrative and not limiting.

In some embodiments, the kernel programs 20 may enable configuration of adaptive beamforming circuitry 26 on the integrated circuit device 12. Indeed, the adaptive beamforming circuitry 26 may represent a circuit design of the kernel program 20 that is configured onto the integrated circuit device 12 (e.g., formed in soft logic). In some embodiments, the adaptive beamforming circuitry 26 may be partially or fully formed in hardened circuitry (e.g., application-specific circuitry of the integrated circuit that is not configurable as programmable logic). The host 18 may use the communication link 24 to cause the adaptive beamforming circuitry 26 to detect or transmit a signal in a particular spatial direction in relation to a phased array 28.

The phased array 28 may include any suitable number and/or type of phased array elements. For example, the phased array 28 may include an array of sensors, such as an array of microphones or RF antenna elements, that may receive signals. The phased array 28 may instead include an array of transmitter elements, such as an array of speakers or RF antenna elements.

The adaptive beamforming circuitry 26 may control the phased array 28 to form a beam 30. Indeed, the adaptive beamforming circuitry 26 may detect or transmit a signal at the beam 30 in a particular spatial direction in relation to the phased array 28. By detecting or transmitting a signal through the various elements of the phased array 28 at specific offsets in time—that is, using different phase offsets for different sensors or transmitters—the beam 30 may focus on a particular spatial direction. Consider the case of signal detection. A signal arriving at the phased array 28 from a particular spatial direction may reach different sensors at different times (e.g., closer sensors first). Thus, selecting specific offsets in time for the different sensors causes the output of the sensors, when added together, to be sensitive to that particular spatial direction (e.g., as shown by the beam 30). Transmitting a signal in a particular direction may operate in a similar way when the phased array 28 contains several transmitter elements. A signal to be transmitted may be provided to the different elements of the phased array 28 at different offsets in time. By selecting specific offsets in time, the resulting transmission signals can be made to constructively interfere (that is, add to one another) in a desired spatial direction to form the beam 30.

Consider, as an example, that the phased array 28 represents an array of microphones at the front of a room. Sound waves coming from a sound source at a location in the room may propagate from the sound source to the microphones. Because each microphone in the array of microphones has a different spatial position in relation to one another, the sound from the sound source may reach the different microphones at different times. By sampling from the microphones according to different specific phase offsets for a specific spatial direction toward the location of the sound source, a signal representing sound waves coming the sound source may be obtained (because those sounds add together in constructive interference) and other sounds may be excluded (because those sounds cancel each other out through destructive interference). Similar principles apply for arrays of other sensors or transmitters, such as radiofrequency (RF) antennas or audio speakers.

In the particular case of adaptive beamforming, as provided in this disclosure, a spatial filtering process is used to focus the beam 30 on a certain angle toward a target. This is very useful, since the radiation pattern detectable by a phased array 28 is environment-dependent. The spatial filtering process used in adaptive beamforming allows for its use in a variety of environments, including environments where jamming signals are present. In effect, adaptive beamforming suppresses jamming signals.

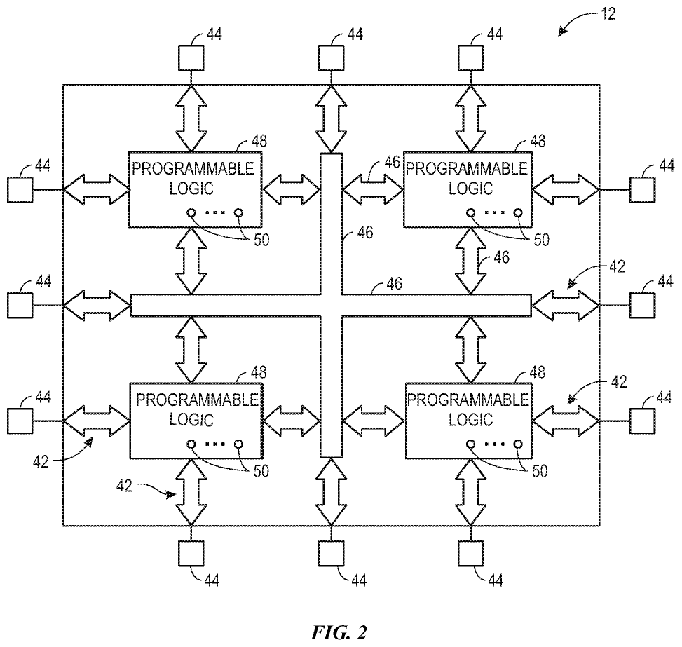

FIG. 2 illustrates an example of the integrated circuit device 12 as a programmable logic device, such as a field-programmable gate array (FPGA). The integrated circuit device 12 may be any other suitable type of integrated circuit device (e.g., an application-specific integrated circuit and/or application-specific standard product). As shown in FIG. 2, the integrated circuit device 12 may have input/output circuitry 42 for driving signals off device and for receiving signals from other devices via input/output pins 44. Interconnection resources 46, such as global and local vertical and horizontal conductive lines and buses, may be used to route signals on integrated circuit device 12. Additionally, interconnection resources 46 may include fixed interconnects (conductive lines) and programmable interconnects (e.g., programmable connections between respective fixed interconnects). Programmable logic 48 may include combinational and sequential logic circuitry, as well as digital signal processing (DSP) circuitry. For example, programmable logic 48 may include look-up tables, registers, and multiplexers. In various embodiments, the programmable logic 48 may be programmed with a configuration that performs a custom logic function. The programmable interconnects associated with interconnection resources may be a part of the programmable logic 48.

Programmable logic devices, such as integrated circuit device 12, may contain programmable elements 50 within the programmable logic 48. For example, as discussed above, a designer (e.g., a customer) may program (e.g., configure) the programmable logic 48 to perform one or more desired functions. By way of example, some programmable logic devices may be programmed by configuring their programmable elements 50 using mask programming arrangements, which is performed during semiconductor manufacturing. Other programmable logic devices are configured after semiconductor fabrication operations have been completed, such as by using electrical programming or laser programming to program their programmable elements 50. In general, programmable elements 50 may be based on any suitable programmable technology, such as fuses, antifuses, electrically-programmable read-only-memory technology, random-access memory cells, mask-programmed elements, and so forth.

Many programmable logic devices are electrically programmed. With electrical programming arrangements, the programmable elements 50 may be formed from one or more memory cells. For example, during programming, configuration data is loaded into the memory cells using pins 44 and input/output circuitry 42. In one embodiment, the memory cells may be implemented as random-access-memory (RAM) cells. The use of memory cells based on RAM technology is described herein is intended to be only one example. Further, because these RAM cells are loaded with configuration data during programming, they are sometimes referred to as configuration RAM cells (CRAM). These memory cells may each provide a corresponding static control output signal that controls the state of an associated logic component in programmable logic 48. For instance, in some embodiments, the output signals may be applied to the gates of metal-oxide-semiconductor (MOS) transistors within the programmable logic 48.

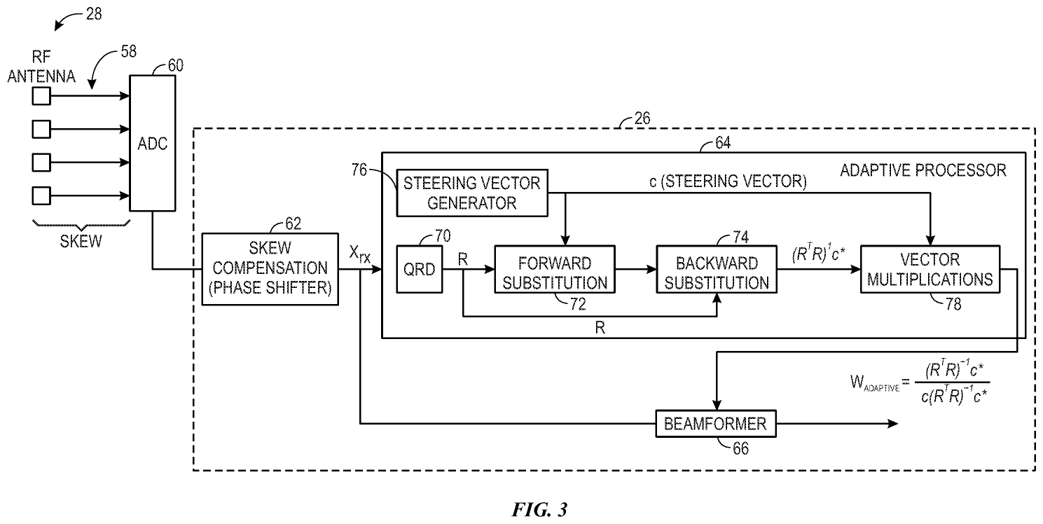

The programmable logic 48 of the integrated circuit 12 may be configured with the adaptive beamforming circuitry 26. In one example, shown in FIG. 3, elements of the phased array 28—shown here as four RF antenna elements, but which may be of any suitable number and/or type—connect via signal paths 58 to analog-to-digital conversion (ADC) circuitry 60. In this way, analog signals received by the elements of the phased array 28 may be converted in the ADC circuitry 60 and provided to the adaptive beamforming circuitry 26 in digital form. The signal paths 58, however, may introduce different amounts of delay, sometimes referred to as skew (due to process variations in manufacturing or slight differences in the design of different signal paths 58). Therefore, the digital signals output by the ADC circuitry 60 may also have these different amounts of skew introduced by the different signal paths 58. These different amounts of skew may be compensated through a calibration process by measuring the skew introduced by the different signal paths 58 (e.g., during the manufacture of the system shown in FIG. 3 or in the field). Any suitable technique may be used to measure the skew, such as through time domain reflectance (TDR) or by adjusting various parameters (e.g., radiation ranges or antenna ranges). The measured skew then can be stored and used to compensate the digital signals output by the ADC circuitry 60.

In the example of FIG. 3, the adaptive beamforming circuitry 26 includes digital skew compensation circuitry 62 to perform this function. The digital skew compensation circuitry 62 applies defined amounts of phase shifting to the different respective digital signals from the ADC circuitry 60 for the different respective elements of the phased array 28. The defined amount of phase shifting of each of these signals may be selected based on the measured amount of skew to cause the digital signals to align. For example, a signal that is received by all of the elements of the phased array 28 at a particular time may be delayed in various amounts by the signal paths 58. As such, the signal may arrive from different elements of the phased array 28 to the ADC circuitry 60 at different times. Therefore, even for a signal that is received by all elements of the phased array 28 at the same time, the resulting digital signals output by the ADC circuitry 60 may be unaligned. After passing through the digital skew compensation circuitry 62, however, the resulting digital signals are aligned as if the skew of the different signal paths 58 were all the same. To ensure the signals are aligned, the compensation circuitry 62 may operate at the rate at which the ADC circuitry 60 digitizes input samples from the phased array 28.

The aligned digital signals that are output by the digital skew compensation circuitry 62 may enter adaptive processor circuitry 64, which may generate beamformer weights (e.g., a matrix corresponding to phase shifts to the elements of the phased array 28 to focus in a particular spatial direction). For example, the adaptive processor circuitry 64 may generate the beamformer weights according to a minimum variance distortionless response (MVDR) technique. The aligned digital signals that are output by the digital skew compensation circuitry 62 may also enter beamformer 66. The beamformer 66 may use the beamformer weights to apply different phase shifts to the aligned digital signals, corresponding to the different elements of the phased array 28, thereby effectively focusing on a particular spatial direction when the results are summed.

The adaptive processor circuitry 64 may generate the beamformer weights in any suitable manner using any suitable circuitry or software. Indeed, the various elements of the adaptive processor circuitry 64 may represent software components, hardware components, and/or configured FPGA soft logic components. In the example shown in FIG. 3, the input signal (here, shown as a matrix of digital signals Xrx) may be decomposed by QR decomposition 70. Additionally or alternatively, other decomposition methods may be used, such as Cholesky decomposition. The resulting matrix R from the QR decomposition 70 may be applied in a forward substitution 72 and a backward substitution 74. The forward substitution 72 may be adjusted based on a steering vector c, which may be generated by a steering vector generator 76. The steering vector generator 76 may provide different steering vectors c to aim the beam at different angles. In other words, the steering vector generator 76 may produce a particular steering vector c when instructed (e.g., by the host 18 of FIG. 1 or the processor 122 of FIG. 6) to focus on a particular angle of the phased array 28. This may be done using circuitry or software that calculates an appropriate steering vector c based on the desired angle of focus and/or using a lookup table (LUT) that retrieves these results from memory. The output of the forward substitution 72 may be applied in the backward substitution 74 along with the result R to produce a value (R^{T}R)¹c*. Vector multiplications 78 performed using this result and the steering vector c may produce the beamformer weights w_{adaptive}=[(R^{T}R)⁻¹c]/[c(R^{T}R)⁻¹c*]. As mentioned above, the beamformer 66 may use the beamformer weights to apply different phase shifts to the input matrix of digital signals corresponding to aligned signals from different elements of the phased array 28, thereby effectively focusing on a particular spatial direction when the results are summed.

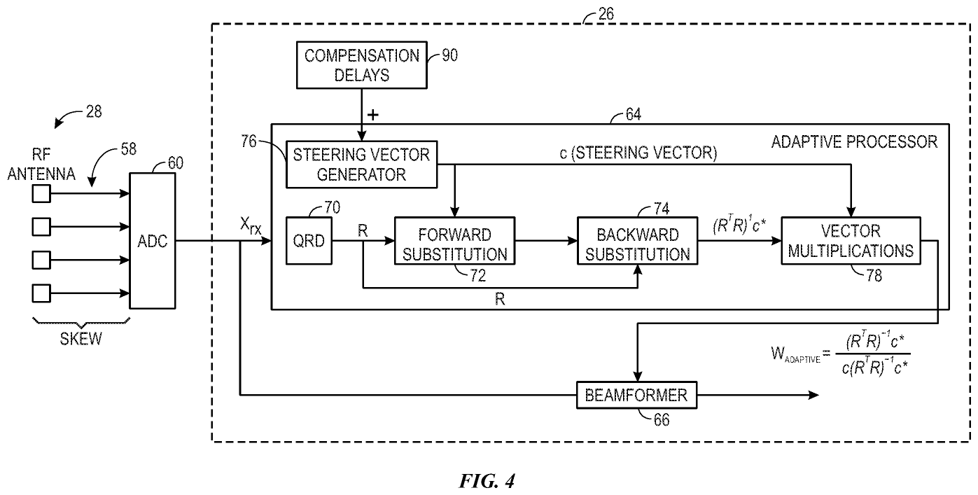

Another example of the adaptive beamforming circuitry 26 appears in FIG. 4. In FIG. 4, elements of the phased array 28—shown here as four RF antenna elements, but which may be of any suitable number and/or type—connect via signal paths 58 to analog-to-digital conversion (ADC) circuitry 60. In this way, analog signals received by the elements of the phased array 28 may be converted in the ADC circuitry 60 and provided to the adaptive beamforming circuitry 26 in digital form. The signal paths 58, however, may introduce different amounts of delay, sometimes referred to as skew (due to process variations in manufacturing or slight differences in the design of different signal paths 58). Therefore, the digital signals output by the ADC circuitry 60 may also have these different amounts of skew introduced by the different signal paths 58. These different amounts of skew may be compensated through a calibration process by measuring the skew introduced by the different signal paths 58 (e.g., during the manufacture of the system shown in FIG. 3 or in the field). Any suitable technique may be used to measure the skew, such as through time domain reflectance (TDR) or by adjusting various parameters (e.g., radiation ranges or antenna ranges). The measured skew then can be stored and used to compensate the digital signals output by the ADC circuitry 60.

Indeed, in the example of FIG. 4, compensation delays 90 may be introduced to the steering vector by the steering vector generator 76 to account for the measured skew, as will be described further below. As such, the adaptive processor circuitry 64 may operate on unaligned signals that still have the different amounts of skew introduced by the different signal paths 58. Accordingly, the digital skew compensation circuitry 62 shown in FIG. 3 may be reduced or eliminated. If the digital skew compensation circuitry 62 (not shown in FIG. 4) were present in the system of FIG. 4, the digital skew compensation circuitry 62 may be reduced in size and thus may take up less die space and/or consume less power, while also not fully compensating for the different amounts of skew introduced by the different signal paths 58. For example, the digital skew compensation circuitry 62 (not shown in FIG. 4) were present in the system of FIG. 4, the digital skew compensation circuitry 62 may partially compensate for the delays (e.g., in the case that the delays are particularly disparate) and the compensation delays 90 used by the steering vector generator 76 may compensate for the rest of the delays. The remainder of the discussion of the system of FIG. 4 will proceed as depicted in FIG. 4, in which the digital skew compensation circuitry 62 is not present.

By avoiding the digital skew compensation circuitry 62, a substantial amount of die space, power, and latency may be preserved. Yet at the same time, the digital signals from the ADC circuitry 60 will not be fully aligned. The unaligned digital signals that are output by the ADC circuitry 60 may enter the adaptive processor circuitry 64, which may generate beamformer weights (e.g., a matrix corresponding to phase shifts to the elements of the phased array 28 to focus in a particular spatial direction). The adaptive processor circuitry 64 may generate the beamformer weights using any suitable technique, such as a minimum variance distortionless response (MVDR) technique. The unaligned digital signals that are output by the digital skew compensation circuitry 62 may also enter the beamformer 66. The beamformer 66 may use the beamformer weights to apply different phase shifts to the digital signals, corresponding to the different elements of the phased array 28, thereby effectively focusing on a particular spatial direction when the results are summed. As will be discussed further below, the beamformer weights themselves may account for the different delays of the signal paths 58. Thus, the unaligned signals from the ADC circuitry 60 may be phase shifted and summed by the beamformer 66 using the beamformer weights without the attendant errors that would otherwise occur.

In the example of FIG. 4, the various components of the adaptive processor circuitry 64 may generally operate in the same manner as described with reference to FIG. 3. However, the steering vector generator 76 may apply (e.g., from memory or storage) compensation delays 90 that are based on the measured skew of the signal paths 58. Because the compensation delays 90 are added to the steering vector constraint c, the skew of the signal paths 58 may be compensated for in a highly efficient manner. Indeed, substantial power savings may result by compensating for the skew of the signal paths 58 in the adaptive processor circuitry 64 as shown in FIG. 4, instead of in-line with the datapath using the digital skew compensation circuitry 62 of FIG. 3. This is because the beamformer weights are often calculated at a much lower rate than the sampling rate of the signals received on the phased array 28. In addition, the compensation delays 90 that are added to the steering vector constraint c may be pre-computed (e.g., using a CPU or other processing circuitry) rather than calculated at runtime. However, in some embodiments, the compensation delays 90 that are added to the steering vector constraint c may be calculated at runtime.

Even though the circuitry shown in FIG. 4 operates on digital signals from the ADC circuitry 60 that is not aligned the by digital skew compensation circuitry 62 of FIG. 3, the output of the beamformer 66 is functionally equivalent (but may be output more quickly, with lower latency). This is shown below in Table 1, which corresponds to the operations performed by the adaptive processor circuitry 64. The diagonal skew matrix K corresponds to skew due to different delays along the signal paths 58. Each diagonal element of the skew matrix K may represent the skew of a corresponding signal path as compared to a reference signal path.

TABLE 1

| No Skew | | |
|---|---|---|
| Between | | |
| Phased | Skew Between | |
| Array | Phased Array | |
| Elements | Elements | |
| (Signals | (Signals | |
| Aligned/ | Unaligned/ | |
| FIG. 3 | FIG. 4) | Definition |
| C | C_{K} | Constraint (Steering Vector) [N × 1] |
| | K | Diagonal Skew matrix [N × N] |
| X | Xₖ = KX | Input Matrix [N × M] |
| Φ = XX^{H} | Φ = X_{K}X_{K}^{H} | Covariance Matrix [N × N] |
| w = Φ⁻¹C | wₖ = Φₖ⁻¹Cₖ | MVDR beamformer weights [N × 1] |
| Y = w^{H}X | Yₖ = wₖ^{H}Xₖ | Beamformer output [1 × M] |

Thus, for the case where unaligned signals are processed (FIG. 4), the output of the beamformer 66, Yₖ, is generated to be equal to the output of the beamformer 66, Y, as in the case where aligned signals are processed (FIG. 3). In other words, Yₖ=Y. This is shown below:

Y=Y_{K}

[(XX^{H})⁻¹C]=[(KX(KX)^{H})⁻¹C_{K}]^{H}KX

C^{H}(XX^{H})^{-H}X=C_{K}^{H}(KXX^{H}K^{H})^{-H}KX

K is diagonal. Therefore, the inverse of K is a trivial reciprocal of the diagonal.

CH(XXH)^{-H}X=C_{K}^{H}(KXX^{H})^{-H}K⁻¹KX

CH(XXH)^{-H}X=C_{K}^{H}K^{-H}(XX^{H})^{-H}X

C^{H}(XX^{H})^{-H}X=(K⁻¹Cₖ)^{H}(XX^{H})^{-H}X

Thus, to satisfy the equation, the constraint vector Cₖ is selected to be Cₖ=KC. In other words, the steering vector c may be modified by the skew matrix in the compensation delays 90 (e.g., delays per element in units of time). As a result, the adaptive processor circuitry 64 produces weights that are compensated for the skew of the elements of the phased array 28.

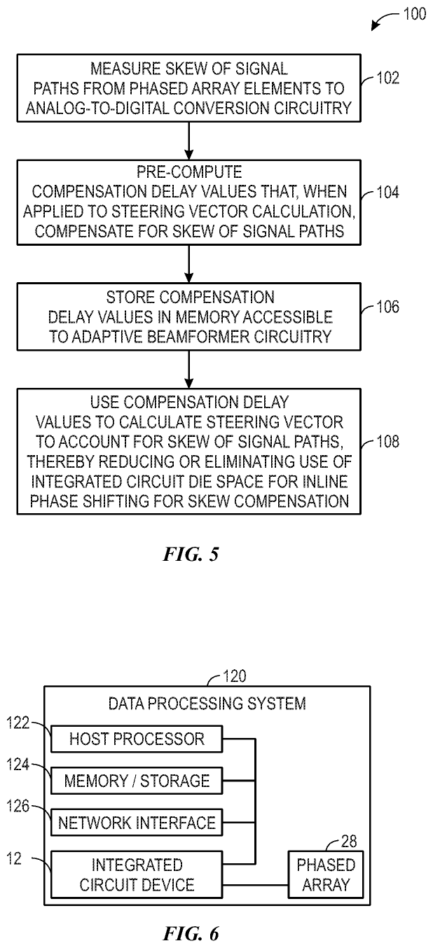

A flowchart 100, shown in FIG. 5, illustrates a method for operating the integrated circuit 12 to provide efficient adaptive beamforming. During an initial calibration phase, which may take place during manufacture or in the field, the skew of the signal paths 58 between elements of the phased array may be measured (process block 102). Based on the measured skew, compensation delays 90 (e.g., the matrix K discussed above) may be pre-computed (process block 104). The compensation delays 90 may be computed so that, when the compensation delays 90 are applied to the steering vector calculation (e.g., Cₖ=KC), the resulting steering vector Cₖ would compensate for the measured skew. The compensation delays 90 may be stored in any suitable form (e.g., memory or other storage) that is accessible to the adaptive processor circuitry 64 (process block 106). The compensation delays 90 may be included in or separate from a program 20 that configures the integrated circuit 12 with the adaptive beamforming circuitry 26. Thereafter, at runtime, the adaptive processor circuitry 64 may use the stored compensation delays 90 to calculate the steering vector Cₖ (process block 108). Because the steering vector Cₖ compensates for the skew of the signal paths 58, the digital skew compensation circuitry 62 may be reduced or eliminated, thereby saving power and/or integrated circuit die space.

The integrated circuit device 12 may be a data processing system or a component included in a data processing system. For example, the integrated circuit device 12 may be a component of a data processing system 120 shown in FIG. 6. The data processing system 120 may include a host processor 122 (e.g., a central-processing unit (CPU)), memory and/or storage circuitry 124, and a network interface 126. The data processing system 120 may include more or fewer components (e.g., electronic display, user interface structures, application specific integrated circuits (ASICs)). The host processor 122 may include any suitable processor, such as an INTEL® Xeon® processor or a reduced-instruction processor (e.g., a reduced instruction set computer (RISC), an Advanced RISC Machine (ARM) processor) that may manage a data processing request for the data processing system 120 (e.g., to perform encryption, decryption, machine learning, video processing, voice recognition, image recognition, data compression, database search ranking, bioinformatics, network security pattern identification, spatial navigation, sensing or transmitting using a phased array 28, or the like). The memory and/or storage circuitry 124 may include random access memory (RAM), read-only memory (ROM), one or more hard drives, flash memory, or the like. The memory and/or storage circuitry 124 may hold data to be processed by the data processing system 120. In some cases, the memory and/or storage circuitry 124 may also store configuration programs (bitstreams) for programming the integrated circuit device 12. The network interface 126 may allow the data processing system 120 to communicate with other electronic devices. The data processing system 120 may include several different packages or may be contained within a single package on a single package substrate. In some cases, the phased array 28 may be a component of the network interface 126 or may be used by the network interface 126 to receive or transmit signals in particular spatial directions.

In one example, the data processing system 120 may be part of a data center that processes a variety of different requests. For instance, the data processing system 120 may receive a data processing request via the network interface 126 to perform encryption, decryption, machine learning, video processing, voice recognition, image recognition, data compression, database search ranking, bioinformatics, network security pattern identification, spatial navigation, digital signal processing, or some other specialized task. Some or all of the components of the data processing system 120 may be virtual machine components running on physical circuitry (e.g., managed by one or more hypervisors or virtual machine managers). Whether physical components or virtual machine components, the various components of the data processing system 120 may be located in the same location or different locations (e.g., on different boards, in different rooms, at different geographic locations). Indeed, the data processing system 120 may be accessible via a computing service provider (CSP) that may provide an interface to customers to use the data processing system 120 (e.g., to run programs and/or perform acceleration tasks) in a cloud computing environment.

While the embodiments set forth in the present disclosure may be susceptible to various modifications and alternative forms, specific embodiments have been shown by way of example in the drawings and have been described in detail herein. However, it should be understood that the disclosure is not intended to be limited to the particular forms disclosed. The disclosure is to cover all modifications, equivalents, and alternatives falling within the spirit and scope of the disclosure as defined by the following appended claims. Moreover, the techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

What is claimed is:

1. A system comprising:
an array of elements that receive respective signals;
analog-to-digital conversion circuitry to digitize the signals, wherein the digitized signals are not aligned in time due to differences in analog delays between the array of elements and the analog-to-digital conversion circuitry; and
adaptive beamforming circuitry that performs beamforming using the digitized signals, wherein the adaptive beamforming circuitry generates beamformer weights that compensate for the analog delays.

2. The system of claim 1, wherein the adaptive beamforming circuitry performs beamforming using the digitized signals without aligning the digitized signals in time.

3. The system of claim 1, wherein the adaptive beamforming circuitry generates a steering vector constraint that compensates for the analog delays.

4. The system of claim 3, wherein the adaptive beamforming circuitry comprises a steering vector generator that generates the steering vector constraint using compensation delay values that, when applied in a steering vector calculation by the steering vector generator, generates the steering vector constraint that compensates for the analog delays.

5. The system of claim 4, wherein the compensation delay values are stored in memory accessible to the steering vector generator of the adaptive beamforming circuitry.

6. The system of claim 4, wherein the compensation delay values represent pre-computed values computed before runtime.

7. The system of claim 4, wherein the compensation delay values are computed at runtime based on measured values of the analog delays between the array of elements and the analog-to-digital conversion circuitry.

8. The system of claim 1, wherein the array of elements comprises an array of radiofrequency antennas.

9. The system of claim 1, wherein the array of elements comprises an array of microphones.

10. A method comprising:
receiving or transmitting a plurality of signals on an array of receiver or transmitter elements, wherein respective receiver or transmitter elements have different signal path delays due at least in part to variations in signal paths used to communicate with the receiver or transmitter elements; and
performing adaptive beamforming on the plurality of signals using a steering vector constraint that compensates for the different signal path delays.

11. The method of claim 10, comprising computing compensation delay values that, when applied in a steering vector calculation, cause the steering vector constraint to compensate for the different signal path delays.

12. The method of claim 11, wherein the compensation delay values are computed before runtime.

13. The method of claim 11, wherein the compensation delay values are computed at runtime.

14. The method of claim 11, wherein the compensation delay values are computed based at least in part on measured values of the different signal path delays.

15. The method of claim 10, comprising:
measuring values of the different signal path delays;
computing compensation delay values based at least in part on the different signal path delays; and
storing the compensation delay values in memory on or accessible to an integrated circuit device used to perform the adaptive beamforming;
wherein the adaptive beamforming is performed using the compensation delay values to generate a beamforming output that compensates for the different signal path delays.

16. The method of claim 10, wherein the method is performed without using separate phase shifts in a digital datapath carrying the plurality of signals to compensate for the different signal path delays.

17. An article of manufacture comprising one or more tangible, non-transitory, machine-readable instructions that, when used to configure a programmable logic device, cause the programmable logic device to implement circuitry comprising:
adaptive processor circuitry configured to generate beamformer weights that compensate for signal path delay errors of a phased array; and
beamformer circuitry configured to use the beamformer weights with digital signals deriving from the phased array to cause the phased array to be sensitive to a particular spatial direction.

18. The article of manufacture of claim 17, wherein the adaptive processor circuitry is configured to generate the beamformer weights using a steering vector constraint that compensates for the signal path delay errors of the phased array.

19. The article of manufacture of claim 18, wherein the adaptive processor circuitry comprises steering vector generator circuitry configured to generate the steering vector constraint using precomputed compensation delays that are based at least in part on a measurement of the signal path delay errors of the phased array.

20. The article of manufacture of claim 17, wherein the instructions, when used to configure the programmable logic device, cause the programmable logic device to implement circuitry that does not include datapath phase shifts that compensate for the signal path delay errors of the phased array.
